(19) United States
(12) Patent Application Publication
(10) Pub. No.: US 2008/0091955 A1
(43) Pub. Date: Apr. 17, 2008

(54) SYSTEM AND METHOD FOR ROTATING DATA IN CRYPTO SYSTEM

(75) Inventor: Nathan P. Leach, Tomball, TX (US)

Correspondence Address: HAYNES AND BOONE, LLP, 901 Main Street, Suite 3100, Dallas, TX, 75202, US

(73) Assignee: PAYMETRIC, INC., Houston, TX (US)

(21) Appl. No.: 11/859,303

(22) Filed: Sep. 21, 2007

Related U.S. Application Data
(60) Provisional application No. 60/846,603, filed on Sep. 22, 2006.

(51) Int. Cl. H04L 9/14; G06F 12/14

(52) U.S. Cl. 713/193

(57) ABSTRACT

A system and method for cryptography. The system may include a cryptography module in communication with a database and configured to perform cryptography operations on data in the database, a rotation module configured to rotate data in the database, and one or more application interfaces configured to remain responsive while the rotation module rotates the data in the database. Rotating the data in the database may include decrypting a stored value in a system with a first key to produce a decrypted value, encrypting the decrypted value with a second key to produce an encrypted value, and replacing the stored value with the encrypted value.

### CROSS-REFERENCE TO RELATED APPLICATIONS

This application claims the benefit of the filing date of U.S. provisional patent application Ser. No. 60/846,603, attorney docket no. 39866.10, filed on Sep. 22, 2006, the disclosures of which are incorporated herein by reference.

### BACKGROUND OF THE DISCLOSURE

Typically, conventional data rotation services are tightly integrated within an application and perform services only for that particular application. A tightly integrated architecture is not suitable for managing encrypted data in high-availability, multiple application software environments where the system periodically changes encryption keys.

One problem with conventional data rotation services is that in some computing environments, managing multiple data rotation services that are specific to each application becomes difficult. Managing multiple data rotation services requires multiple methods or procedures for managing each encryption key configuration, possibly across many different applications. This added complexity makes it difficult to introduce a change to an encryption key policy, because the change must be made to each data rotation service. Another problem with conventional data rotation services is the additional burden on available resources required to perform a data rotation. The burden may deplete system resources, and cause the application to become unavailable or perform poorly during a data rotation.

It would be beneficial to applications requiring high availability to provide a software system that performs all cryptography operations, including encryption key changes, using its own resources so that applications accessing the system may remain online during data rotations.

### SUMMARY OF THE DISCLOSURE

A software system used for managing encrypted data in a software environment is provided. Embodiments of the invention may provide a method for rotating data, including decrypting a stored value stored at a system with a first key to produce a decrypted value, encrypting the decrypted value with a second key to produce an encrypted value, replacing the stored value with the encrypted value, and maintaining the availability of one or more applications communicably coupled to the system during the decrypting, encrypting, and replacing. The one or more applications may request the stored value.

Embodiments of the invention may further provide a computer program embodied on a computer-usable medium, the medium having stored thereon a sequence of instructions which, when executed by a processor, causes the processor to execute a method for rotating data, the method including decrypting a stored value stored at a system with a first key to produce a decrypted value, encrypting the decrypted value with a second key to produce an encrypted value, replacing the stored value with the encrypted value, and maintaining the availability of one or more applications communicably coupled to the system during the decrypting, encrypting, and replacing. The one or more applications may request the stored value.

Embodiments of the invention may further provide a system including a cryptography module in communication with a database and configured to perform cryptography operations on data in the database, a rotation module configured to rotate data in the database, and one or more application interfaces configured to remain responsive while the rotation module rotates the data in the database. Rotating the data in the database includes decrypting a stored value in a system with a first key to produce a decrypted value, encrypting the decrypted value with a second key to produce an encrypted value, and replacing the stored value with the encrypted value.

Embodiments of the invention may further provide a method for rotating data, including decrypting means for decrypting a stored value stored at a system with a first key to produce a decrypted value, encrypting means for encrypting the decrypted value with a second key to produce an encrypted value, replacing means for replacing the stored value with the encrypted value, and maintaining means for maintaining the availability of one or more applications communicably coupled to the system during the decrypting, encrypting, and replacing. The one or more applications may request the stored value.

### DESCRIPTION OF THE DRAWINGS

FIG. 1 shows schematically an illustrative embodiment of an enterprise software environment including a crypto system according to an embodiment of the present disclosure.

FIG. 2A shows schematically an illustrative embodiment of how an application communicably coupled to a crypto system of the present disclosure requests data encryption services and receives a token.

FIG. 2B show schematically an illustrative embodiment of how an application communicably coupled to a crypto system of the present disclosure requests data encryption services and provides an application-defined token.

FIG. 3 shows schematically an illustrative embodiment of how an application communicably coupled to an embodiment of a crypto system of the present disclosure may request decryption services by using a token.

FIG. 4 shows schematically an illustrative embodiment of how an application communicably coupled to an embodiment of a crypto system of the present disclosure may encrypt data and pass the resulting token to another application.

FIG. 5 shows schematically an illustrative embodiment of how an application communicably coupled to an embodiment of a crypto system of the present disclosure may request the decrypted value of data by using a shared token.

FIG. 6 shows schematically an illustrative embodiment of an algorithm implementing a rotation service according to the present disclosure.

### DETAILED DESCRIPTION

The present disclosure relates generally to cryptography management in an enterprise software environment. More specifically, the present disclosure relates to a system for allowing a centralized data management service for encrypted data.

An embodiment of a crypto system in accordance with the present disclosure performs centralized data management and various cryptographic operations for one or more applications. The crypto system handles various cryptography functions for multiple applications, including, without limitation, encryption, mass encryption, decryption and data rotation. Further, the encryption system performs cryptography functions using its own resources, thereby reducing the burden on application resources. The crypto system includes a data storage system that enables storage of data. A token mechanism allows the one or more applications to submit data to the crypto system and request data from the crypto system.

Further, the crypto system may support performance balancing and load balancing features to support high-transaction and high-availability environments. The crypto system may also be able to perform operations such as key status metrics, data usage, purging, reporting and logging.

In describing selected embodiments, various objects or components may be implemented as computing modules. These modules may be general-purpose, or they may have dedicated functions such as memory management, program flow, instruction processing, object storage, etc. The modules can be implemented in any way known in the art. For example, in one embodiment a module is implemented in a hardware circuit including custom VLSI circuits or gate arrays, off-the-shelf semiconductors such as logic chips, transistors, or other discrete components. One or more of the modules may also be implemented in programmable hardware devices such as field programmable gate arrays, programmable array logic, programmable logic devices or the like.

In an exemplary embodiment, one or more of the modules are implemented in software for execution by various types of processors. An identified module of executable code may, for instance, may include one or more physical or logical blocks of computer instructions that may, for instance, be organized as an object, procedure, or function. Further, the executables of an identified module need not be physically located together, but may include disparate instructions stored in different locations that, when joined logically together, include the module and achieve the stated purpose for the module. A “module” of executable code could be a single instruction, or many instructions, and may be distributed over several different code segments, among different programs, and across several memory devices. Similarly, operational data may be identified and illustrated in association with one or more modules, and may be embodied in any suitable form and organized within any suitable type of data structure. The operational data may be collected as a single data set, or may be distributed over different locations including over different storage devices, and may exist, at least partially, as electronic signals on a system or network.

In some embodiments, higher-level components may be used as modules. For example, one module may include an entire computer acting as a network node. Another module may include of an off-the-shelf or custom program, such as a database management system. These higher-level modules may be decomposable into smaller hardware or software modules corresponding to different parts of a software program and identifiable chips (such as memory chips, ASICs, or a CPU) within a computer.

One type of module is a “network.” A network module defines a communications path between endpoints and may include an arbitrary amount of intermediate modules. A network module may encompass various pieces of hardware, such as cables, routers, and modems, as well the software necessary to use that hardware. Another network module may encompass system calls or device-specific mechanisms such as shared memory, pipes, or system messaging services. A third network module may use calling conventions within a computing module, such as a computer language or execution environment. Information transmitted using the network module may be carried upon an underlying protocol, such as HTTP, BXXP, or SMTP, or it may define its own transport over TCP/IP, IPX/SPX, Token Ring, ATM, etc. To assure proper transmission, both the underlying protocol as well as the format protocol may split the information into separate pieces, wrap the information in an envelope, or both. Further, a network module may transform the data through the use of one or more computing modules.

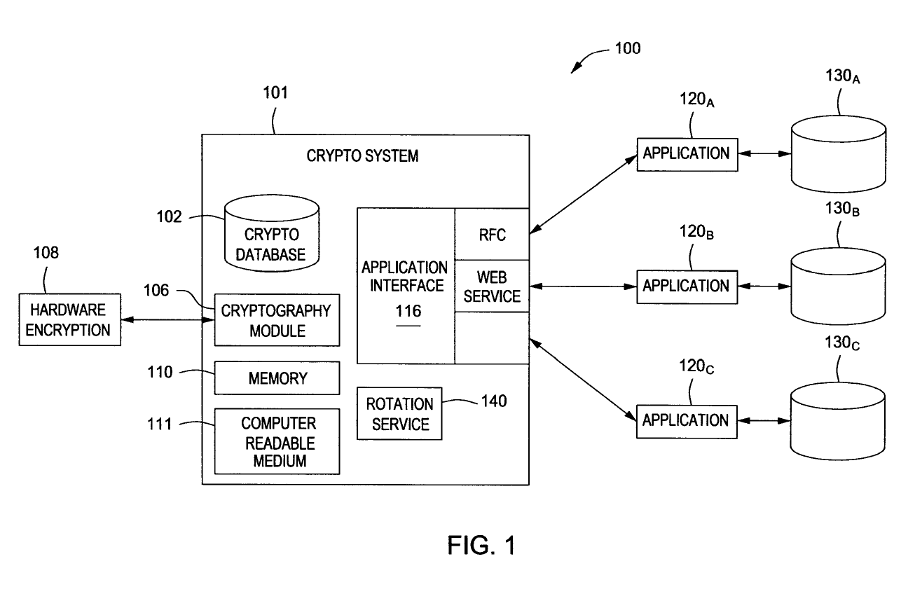

Referring to FIG. 1, illustrated is an enterprise software environment 100 including an exemplary embodiment of a crypto system 101. The crypto system 101 includes a crypto database 102, a cryptography module 106, memory 110 and a computer readable medium 111, one or more application interfaces 116, and a data rotation service 140. In one embodiment, the crypto system 101 is communicably coupled to encryption hardware 108, such as a network-connected hardware security module (HSM). Further, one or more applications 120A-C may be communicably coupled to the crypto system 101. Each application 120A-C may be communicably coupled to an application database 130A-C.

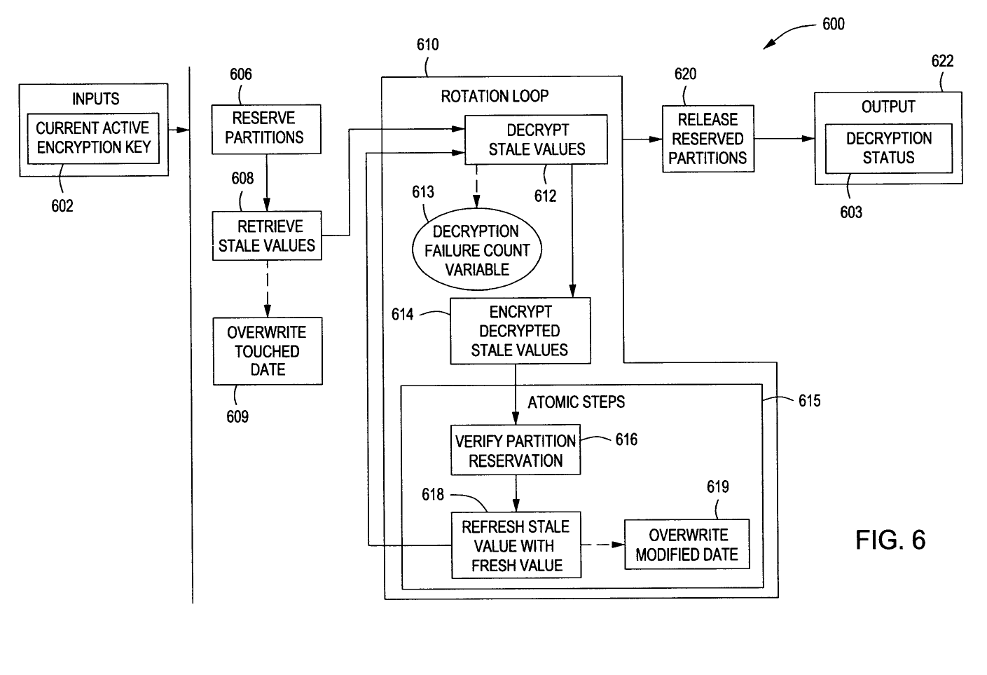

The crypto database 102 may include application data that has been encrypted by the crypto module 106 with an active encryption key. The crypto database 102 might store a reference to more than one active encryption key at any one time. For example, an active encryption key may be assigned to one or more applications. Further, active encryption keys might be rotated periodically. When an active encryption key is rotated, the data may also be rotated. The process of rotating encryption keys and rotating data is discussed in more detail below with respect to FIG. 6. The crypto system 101 may define one or more data rotation and archival policies for each active encryption key.

One or more characteristics may be associated with the application data. For example, the application data may include such characteristics as a creation date (when the data was first created), and a “reference” date (when the data was last referenced).

In one embodiment, the crypto database 102 is a MICROSOFT SQL SERVER implementation operating on a MICROSOFT WINDOWS-based operating system. In a second embodiment, the crypto database 102 is an ORACLE database operating on a MICROSOFT WINDOWS-based operating system. In a third embodiment, the crypto database 102 is a PostgreSQL database operating on a LINUX-based operating system. In a fourth embodiment, the crypto database 102 operates on a UNIX-based operating system. It should be understood that the foregoing examples are merely embodiments and that the crypto database 102 may be any database implementation operating on any operating system.

In an exemplary embodiment, the cryptography module 106 takes one or more inputs, which may include instructions, a key, and data in encrypted or unencrypted form. The cryptography module 106 outputs data in encrypted or unencrypted form. A function of the cryptography module 106 is to perform cryptography operations including, without limitation, encryption and decryption of data. In one embodiment, the cryptography module 106 includes implementations of one or more cryptography algorithms. For example, in a first embodiment, the cryptography module 106 includes an implementation of a PCI DSS-compliant technology based on the National Institute of Standards and Technology (NIST) Advanced Encryption Standard (AES) cryptography technology. In a second embodiment, the cryptography module 106 includes an implementation of RSA encryption technology, such as the RC4 algorithm. In a third embodiment, the cryptography module 106 includes an implementation of MICROSOFT cryptography technology, such as the MICROSOFT Crypto API or any other MICROSOFT Cryptographic Service Provider (CSP). A fourth embodiment of the cryptography module 106 includes implementations of protocols that may be used to communicate with encryption hardware 108. For example, the cryptography module 106 might include an implementation of the RSA PKCS 11 API. The foregoing are merely examples of cryptography technology that may be used in embodiments of the present disclosure and are not meant to be limiting.

In one embodiment, upon receiving input, the cryptography module 106 performs the requested operations on the data using the key in accordance with the instructions. For example, if an instruction includes encryption instructions, then the cryptography module 106 encrypts the data with the key. The cryptography module 106 may run on one computer, or it may run on multiple computers for purposes of load balancing and failover.

The crypto system 101 is communicably coupled to one or more applications 120A-C. An application interface 116 enables communication between an application 120A-C and the crypto system 101. Possible application interfaces 116 include, without limitation, Remote Procedure Calls (RPC) and web services. For example, in one embodiment, the RPC application interface is the Remote Function Call (RFC), which is an application interface used by SAP systems. Applications 120A-C may submit data requests to the crypto system 101 via an application interface 116.

Three applications 120A-C are depicted in FIG. 1, however any number of applications 120A-C are possible. The applications 120A-C may be high-availability systems that require minimal down-time. Each application 120A-C may be communicably coupled to one or more application databases 130A-C. In one embodiment, the application databases 130A-C are MICROSOFT SQL SERVER implementations operating on a MICROSOFT WINDOWS 2003 SERVER operating system. In a second embodiment, the application databases 130A-C are ORACLE databases operating on a MICROSOFT WINDOWS 2003 SERVER operating system. In a third embodiment, the application databases 130A-C are PostgreSQL databases operating on a LINUX-based operating system. In a fourth embodiment, the application databases 130A-C operate on a UNIX operating system. It should be understood that the application databases 130A-C may be any database implementation operating on any operating system, and the foregoing embodiments are not meant to be limiting.

In an embodiment, the applications 120A-C and the application databases 130A-C do not locally store certain application data. For example, sensitive data, such as credit card information or any kind of personally identifiable information (PII), might not be stored local to the applications 120A-C or the application databases 130A-C. In one embodiment, instead of storing certain application data, the applications 120A-C and the application databases 130A-C only store tokens. A token is a data item generated by the crypto system 101 and returned to applications 120A-C in response to a request to store data. Applications 120A-C store the token and later use the token to request data.

In one embodiment, a token is a text string that is 25 characters in length. A sample token in accordance with such an embodiment is as follows:

-VVVV-SSSS-NNNNNNNNNNNNNC

In one embodiment utilizing the above sample token, indices 0, 5, and 10 are the dash “−” character. The indices 1 through 4 (represented by the placeholder “V”) represent a base-16 encoded integer value that is a version indicator used to determine the code path to take when evaluating the token during decryption requests. If the length of the unencrypted string is between 1 and 4 characters, then indices 6 through 9 (represented by the placeholder “S”) are blank spaces. Otherwise, if the length of the unencrypted string is more than 4 characters, then the indices 6 through 9 represent the last four characters of the unencrypted string. In one embodiment, the unencrypted string is a credit-card number, and indices 6-9 represent the last four digits of the credit-card number. Zero length strings may not be encrypted.

Indices 11 through 23 (represented by the placeholder “N”) are a base-32 representation of a 64-bit unsigned number. In one embodiment, indices 11-23 represent a unique identifier that is associated with the encrypted string in the database. That is, taken together, the indices 11 through 23 may serve as a primary key that the database can use to locate the record that includes the encrypted string. In one embodiment, each index 12 through 23 is a base 32 value. Finally, index 24 is a check digit that is calculated by adding the values of the base-32 characters and representing it as a modulo 32 number.

The token embodiment set forth above may be stored in plain-text data fields in applications 120A-C and application databases 130A-C. Further, the token embodiment above may also be represented using text-based markup languages, such as XML. Encoding the token using a text-based markup language facilitates transport of the token among disparate platforms.

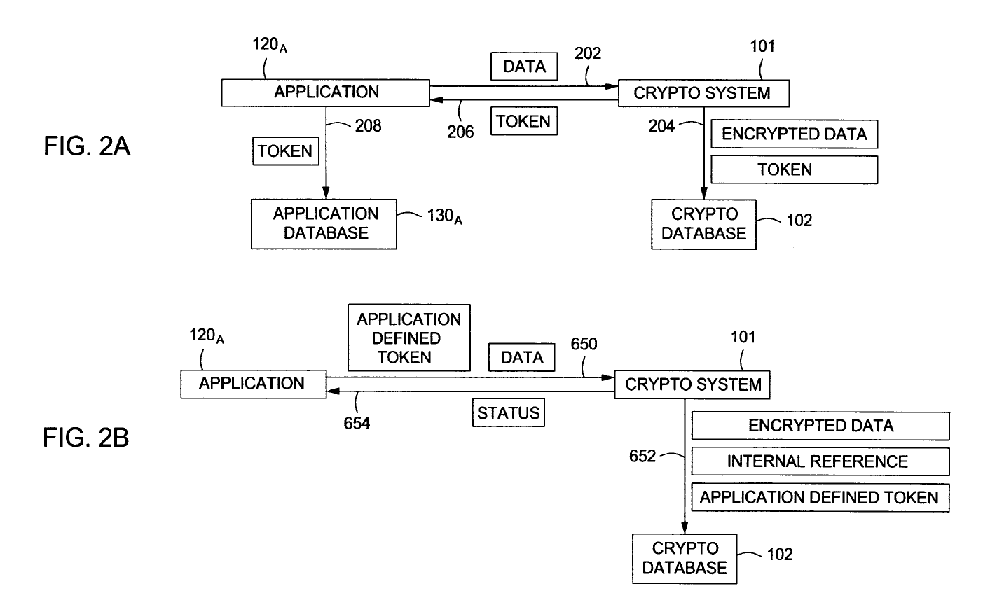

Referring now to FIG. 2A, illustrated is an embodiment of a token-based method for an application 120A to encrypt application data using a crypto system 101. Arrow 202 shows the application 120A submitting data to the crypto system 101 via the application interface 116. The crypto system 101 encrypts the data using the cryptography module 106, and as illustrated by arrow 204, the crypto system 101 submits the encrypted data to the crypto database 102 for storage. Crypto system 101 generates a token and returns the token to the application 120A in a step 206. After receiving the token, the application 120A in a step 208 stores the token in the application database 130A.

Referring now to FIG. 2B, illustrated is an embodiment of an token-based method for an application 120A to encrypt application data using the crypto system 101, wherein the application 120A defines the token. As shown by arrow 650, in one embodiment, the application 120A supplies an application-defined token to the crypto system 101 at the time the application 120A submits data to the crypto system 101. For example, in one embodiment, the application defined token is the social security number of a credit card holder. The crypto system 101 encrypts the data using the cryptography module 106 and generates an internal reference that is associated with the application-defined token. As illustrated by arrow 652, the crypto system 101 submits the encrypted data, the application-defined token, and the internal reference to the crypto database 102 for storage. The crypto system 101 then returns a status response to the application 120A as shown by arrow 654.

In certain situations, using an application-defined token, as described with respect to FIG. 2B, may be more appropriate than using a token defined by the crypto system 101, as described with respect to FIG. 2A. For example, an application 120A-C may be unable to store a token generated by the crypto system 101. This may occur if the token generated by the crypto system 101 is too large for the fields defined in a table of an application database 130A-C. Another scenario where an application-defined token may be more appropriate than a crypto system-defined 101 token is the situation where an application database 130A-C is part of a legacy system that does not support adding extra columns to a table of the application database 130A-C. In one embodiment, more than one application-defined token may be associated with an encrypted value. For example, in one embodiment, the encrypted value may be a credit card number, and one application-defined token may be the social security number of the credit card holder, and a second application-defined token may be an employee identification number of the credit card holder. Applications 120A-C may then submit either the social security number of the employee identification number as a token to the retrieve the encrypted information from the crypto system 101, as explained in more detail below.

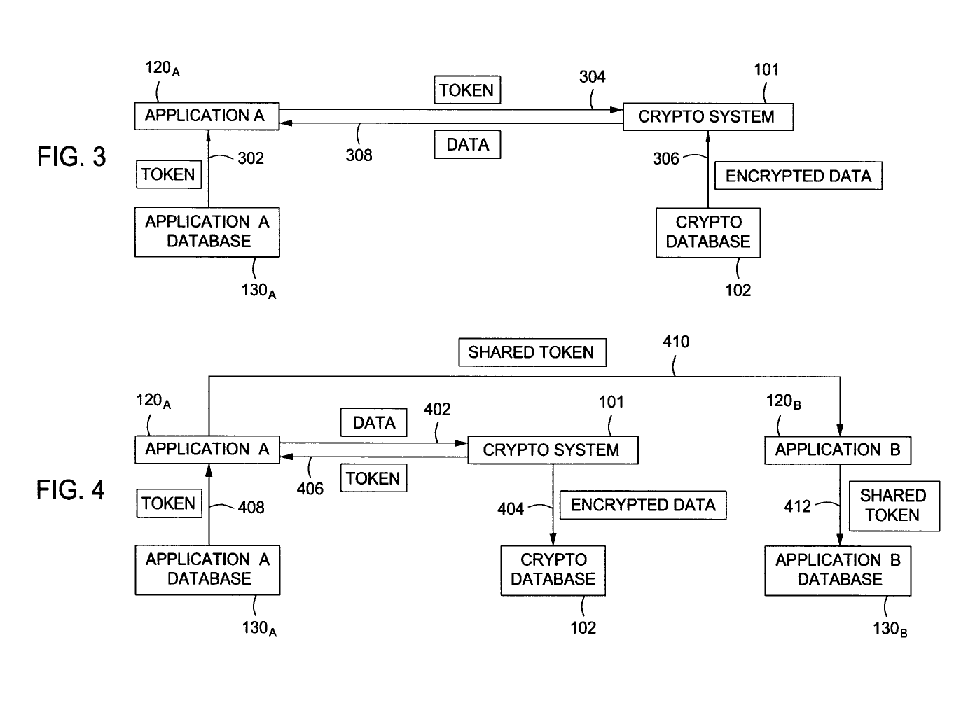

Referring now to FIG. 3, illustrated is an embodiment of a token-based method for an application 120A to retrieve application data stored on a crypto database 102. Arrow 302 represents the step of the application 120A retrieving a token from the application database 130A. In another embodiment, instead of retrieving a token from the application database 130A, the application 120A generates an application-defined token. The application 120A submits the token to the crypto system 101 via the application interface 116 as shown by arrow 304. Then, as exemplified by arrow 306, the crypto system 101 retrieves the encrypted data corresponding to the token from the crypto database 102. The crypto system 101 decrypts the encrypted data using the cryptography module 106. As illustrated by arrow 308, the crypto system 101 then returns the unencrypted data to the application 120A.

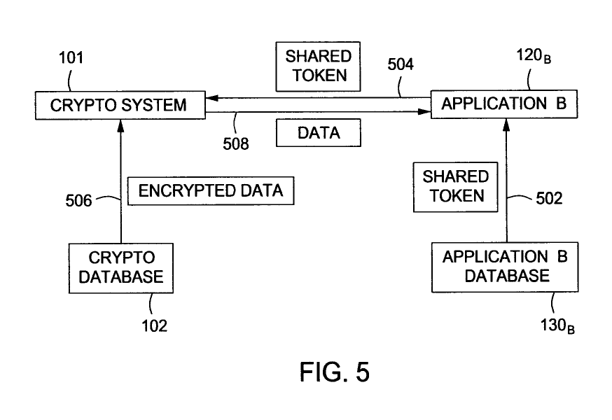

Referring now to FIG. 4, illustrated is an embodiment of a token-based method for an application 120A to encrypt application data using the crypto system 101 and share the encrypted data with another application 120B. The embodiment illustrated in FIG. 4 is similar to the embodiment illustrated in FIG. 2. Arrows 402, 404, 406, and 408 in FIG. 4 correspond to the actions represented by arrows 202, 204, 206 and 208 respectively. In addition to the steps 202, 204, 206 and 208 described in FIG. 2, the embodiment of FIG. 4 further includes a step 410 wherein the application 120A shares the token received from the crypto system 101 with the application 120B. After the application 120B receives the shared token from the application 120A, the application 120B stores the token in the application database 130B, as shown by arrow 412.

Referring now to FIG. 5, illustrated is an embodiment of a token-based method for an application 120B to retrieve application data stored on a crypto system 101 using a shared token. The embodiment of FIG. 5 is similar to the embodiment illustrated in FIG. 3, except that the application 120B is substituted for the application 120A, and the application database 130B is substituted for the application database 130A. Accordingly, arrow 502 represents the application 120B retrieving a shared token from the application database 130A. The application 120B submits the shared token to the crypto system 101 via the application interface 116 as shown by arrow 504. Then, as exemplified by arrow 506, the crypto system 101 retrieves the encrypted data corresponding to the shared token. The crypto system 101 decrypts the encrypted data using the cryptography module 106. As illustrated by arrow 508, the crypto system 101 then returns the unencrypted data to the application 120B.

In an exemplary embodiment, the crypto system 101 periodically performs a key rotation operation. In one embodiment, keys are stored only in the cryptography module 106 and references to keys are stored in the crypto database 102. A key rotation operation may include replacing the current active encryption key with a new active encryption key. In an embodiment, when the crypto system 101 performs a key rotation, the crypto system 101 also performs a data rotation operation in response to a key rotation. In one embodiment, the data rotation operation occurs at fixed intervals. For example, the crypto system 101 might be configured to perform the data rotation operation during low-volume periods. In a second embodiment, the crypto system 101 is configured to perform the data rotation operation at variable intervals. In a third embodiment, a user of the crypto system 101 initiates a data rotation operation. For example, a user might issue a data rotation operation command to the crypto system 101 from a terminal that is communicably coupled to the crypto system 101.

According to one embodiment, the data rotation service 140 monitors a crypto system 101 and performs data rotation operations upon the occurrence of a key rotation operation. In one embodiment, the data rotation service 140 executes on a single computer that is communicably coupled to the crypto database 102. in a second embodiment, separate instances of the data rotation service 140 operate concurrently on more than one system, thereby allowing clusters of systems to perform operations on partitions of a total data set.

Data rotation may include decrypting data that was encrypted with a previous active encryption key (“stale” data) and encrypting the decrypted data with the current active encryption key to produce “fresh” data. Thus, data rotation ensures that the data stored in the crypto database 102 is always fresh, i.e., encrypted with the then-current active encryption key. The data rotation service 140 utilizes the cryptography module 106 to decrypt and encrypt data.

Multiple references to decryption keys may be stored in the crypto database 102, the memory 110, or the computer readable medium 111. For example, the crypto database 102, the memory 110, or the computer readable medium 111 might include references to decryption keys that can decrypt stale data. Storing references to decryption keys enables the crypto system 101 to continue processing application 120A-C requests for data even if data rotation is not yet complete. For example, at some point during a data rotation, the encrypted data stored on the crypto database 102 may be in a state where one or more partitions include fresh data, but the remainder of the partitions include stale data. It is also possible that a partition may contain a combination of stale data and fresh data. Because the crypto system 101 has access to previous active encryption keys and the current active encryption key, the crypto system 101 can decrypt both stale data and fresh data. Thus, the crypto system 101 can continue to respond to the applications' 120A-C requests for data even if data rotation is not complete.

Referring now to FIG. 6, illustrated is a flowchart diagramming an embodiment of an algorithm 600 implementing the data rotation service 140. The algorithm 600 takes in one or more inputs, which may include a reference to a current active encryption key 602, and outputs a decryption status 603. A function of the algorithm 600 is to rotate data stored in the crypto database 102.

In a reservation step 606, the algorithm 600 reserves a partition containing stale data stored in the crypto database 102. In an embodiment, each partition has an associated partition reservation time. The partition reservation time reflects when the partition was last reserved. When the algorithm 600 reserves a partition, the algorithm 600 also updates the partition reservation time. In one embodiment, the algorithm 600 may reserve partitions that are currently reserved by operations that have timed out.

At a retrieval step 608, the algorithm 600 retrieves all stale values in the reserved partition from the crypto database 102. The algorithm 600 stores the stale values in a data structure. One embodiment uses a one-dimensional array as the data structure. During the retrieval step 608, the algorithm 600 does not modify the reference date of the stale values when they are read. In one embodiment, if the crypto database 102 automatically updates the reference date of the stale values when they are read in the data retrieval step 608, then the algorithm 600 notes the original reference date of the stale value before reading the stale value, and after reading the stale value, the algorithm 600 updates the reference date to reflect the original read date.

Then, the algorithm 600 performs a data rotation loop 610. In one embodiment, the data rotation loop 610 includes a decryption step 612, an encryption step 614, and one or more atomic steps 615. One function of the data rotation loop 610 is to decrypt stale values, encrypt such stale values with the current active encryption key to produce fresh values, and replace stale values in the crypto database 102 with fresh values.

At the decryption step 612, beginning with the first stale value in the array, the algorithm 600 decrypts the stale value with the corresponding decryption key. It is possible that an attempt to decrypt a stale value will fail. For example, one reason for decryption failure may be that the corresponding decryption key is not available on the crypto system 101. Another reason for decryption failure may be that the stale value is corrupt. Each time the decryption fails for any reason, the decryption count failure variable 613 is incremented by one.

Then, at an encryption step 614, the algorithm 600 encrypts the decrypted stale value with the current active encryption key 604 to produce a fresh value.

In an exemplary embodiment, the atomic steps 615 include a verifying step 616 and a refresh step 618. The atomic steps 615 must all complete successfully, otherwise any effects of each atomic step must be undone. At the verifying step 616, the algorithm 600 verifies that the partition is still reserved and updates the partition reservation time. If the partition is not still reserved, then the atomic steps 615 fail. Then in a refresh step 618, the algorithm 600 overwrites the stale value in the crypto database 102 with the corresponding fresh value. If overwriting the stale value fails, then the atomic steps 615 fail.

The algorithm 600 does not modify the reference date of the overwritten data during the refresh step 618. In one embodiment, if the crypto database 102 automatically updates the reference date of the overwritten data, then at step 619, the algorithm 600 notes the original modification date of the stale value before overwriting the stale value, and after overwriting the stale value, the algorithm 600 modifies the reference date of the fresh value to reflect the original modification date.

Then at a release step 620, the algorithm 600 releases the reserved partition. Finally at an output step 622, the algorithm 600 outputs the decryption status 603, which may include a decryption failure count 613, and resets the decryption count failure variable 613 to zero. In one embodiment, the algorithm 600 repeats until all stale data in each partition has been processed.

It should be understood that the above algorithm 600 is merely one embodiment of the present disclosure. Accordingly, other implementations using different data structures and modules may be used. For example, in one embodiment of the algorithm 600, only a portion of the stale values in a partition are retrieved in the data retrieval step 608. Accordingly, in such an embodiment, the algorithm 600 repeats, each time processing a different subset of stale values in the partition, until at least one attempt has been made to refresh each stale value in the partition. The algorithm 600 may then be repeated to process one or more partitions. In one embodiment, the algorithm 600 repeats until all stale data in all partitions is replaced with fresh data.

Storing encrypted data on a centralized storage system, such as the crypto system 101 of the present disclosure has several benefits. One benefit of centralized storage is stronger access control and support for PCI DSS-compliant backups. Further, a single purge and archival policy may be established for all sensitive data. Another benefit is that a wide range of enterprise encryption needs may be supported by the server. That is, a crypto system 101 of the present disclosure is data agnostic and application-independent. In addition, different cryptography keys may be assigned to collections of applications with varying data rotation and archival policies. Finally, another benefit of a crypto system 101 of the present disclosure is that multiple encryption technologies may be simultaneously supported, including, without limitation, software and hardware based cryptography technologies.

The tokens described herein as part of the present disclosure also provide certain benefits. For example, the structure of a token generated by the crypto system 101 includes the last four characters of the encrypted data in unencrypted form. This feature is particularly useful when the encrypted data involves storing a credit card number. For example, in one embodiment, the token may include the last four digits of the encrypted credit card number in unencrypted form. In such an embodiment, the applications 120A-C do not need to submit a request to the crypto system 101 for unencrypted data if the applications 120A-C only need the last four digits of the credit card number. Also, a human operator would be able to read the last four digits of the credit card number simply by examining the token. Further, the ability to use application-defined tokens provides flexibility when using the applications 120A-C or application databases 130A-C are legacy systems that may not support the storage of a token defined by the crypto system 101.

The manner of usage and operation of the present disclosure should be apparent to one of ordinary skill having the benefit of the present disclosure. The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The systems and methods disclosed and claimed herein can be made and executed without undue experimentation in light of the present disclosure. While the systems and methods of this invention have been described in terms of embodiments, it will be apparent to those of skill in the art that variations may be applied to the systems and in the steps or in the sequence of steps of the methods described herein without departing from the concept, spirit and scope of the invention. Further, since numerous modifications and changes will readily occur to those skilled in the art, it is not desired to limit the invention to the exact construction and operation shown and described, and accordingly, all such similar substitutes and modifications apparent to those skilled in the art are deemed to be within the scope and concept of the invention.

Although the present disclosure has described embodiments relating to specific networked enterprise environments, it is understood that the apparatus, systems and methods described herein could applied to other environments.

Any spatial references used herein, such as, “upper,” “lower,” “above,” “below,” “between,” “vertical,” “horizontal,” “angular,” “upward” “downward,” “side-to-side,” “left-to-right,” “right-to-left,” “top-to-bottom,” “bottom-to-top,” “left,” “right,” etc., are for the purpose of illustration only and do not limit the specific orientation or location of the structure described above. Additionally, in several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

What is claimed is:

1. A method for rotating data, comprising:
decrypting a stored value stored at a system with a first key to produce a decrypted value;
encrypting the decrypted value with a second key to produce an encrypted value;
replacing the stored value with the encrypted value; and
maintaining the availability of one or more applications communicably coupled to the system during the decrypting, encrypting, and replacing, wherein the one or more applications may request the stored value.

2. The method of claim 1, wherein replacing the stored value comprises performing an operation comprising a plurality of steps configured to replace the stored value with the encrypted value, and a result of each of the plurality of steps is undone if any one of the plurality of steps fails.

3. The method of claim 2, further comprising partitioning the stored values into a plurality of partitions, and reserving one or more of the plurality of partitions as reserved partitions, wherein the operation comprises a step of determining whether the reserved partitions are still reserved.

4. The method of claim 1, wherein replacing the stored value comprises modifying a date representing when the stored value was last referenced to reflect an original reference date.

5. The method of claim 1, wherein decrypting the stored value comprises modifying a date representing when the stored value was last referenced to reflect an original reference date.

6. The method of claim 1, wherein at least one of decrypting the stored value or encrypting the decrypted value comprises encrypting or decrypting data using a hardware-based encryption technology.

7. A computer program embodied on a computer-usable medium, the medium having stored thereon a sequence of instructions which, when executed by a processor, causes the processor to execute a method for rotating data, the method comprising:
decrypting a stored value stored at a system with a first key to produce a decrypted value;
encrypting the decrypted value with a second key to produce an encrypted value;
replacing the stored value with the encrypted value; and
maintaining the availability of one or more applications communicably coupled to the system during the decrypting, encrypting, and replacing, wherein the one or more applications may request the stored value.

8. The computer program of claim 7, wherein replacing the stored value comprises performing an operation comprising a plurality of steps configured to replace the stored value with the encrypted value, and a result of each of the plurality of steps is undone if any one of the plurality of steps fails.

9. The method of claim 8, further comprising partitioning the stored values into a plurality of partitions, and reserving one or more of the plurality of partitions as reserved partitions, wherein the operation comprises a step of determining whether the reserved partitions are still reserved.

10. The computer program of claim 7, wherein replacing the stored value comprises modifying a date representing when the stored value was last referenced to reflect an original reference date.

11. The computer program of claim 7, wherein decrypting the stored value comprises modifying a date representing when the stored value was last referenced to reflect an original reference date.

12. The computer program of claim 7, wherein at least one of decrypting the stored value or encrypting the decrypted value comprises encrypting or decrypting data using a hardware-based encryption technology.

13. A system for cryptography, comprising:
a cryptography module in communication with a database and configured to perform cryptography operations on data in the database;
a rotation module configured to rotate data in the database; and
one or more application interfaces configured to remain responsive while the rotation module rotates the data in the database, wherein rotating the data in the database comprises decrypting a stored value in a system with a first key to produce a decrypted value; encrypting the decrypted value with a second key to produce an encrypted value; and replacing the stored value with the encrypted value.

14. The system of claim 13, wherein the one or more application interfaces comprises at least one of Remote Procedure Call (RPC) or web service interfaces.

15. The system of claim 13, wherein the cryptography module is configured to communicate with a hardware encryption technology.

16. The system of claim 15, wherein the hardware encryption technology provides the second key used to produce the encrypted value.

17. The system of claim 15, wherein the hardware encryption technology performs the decrypting and encrypting during a data rotation.

18. The system of claim 13, wherein the rotation service is a first rotation service operating concurrently with a second rotation service embodied on the computer-readable medium, and each of the first and second rotation services rotates different portions of data stored in the database.

19. A method for rotating data, comprising:
decrypting means for decrypting a stored value stored at a system with a first key to produce a decrypted value;
encrypting means for encrypting the decrypted value with a second key to produce an encrypted value;
replacing means for replacing the stored value with the encrypted value; and
maintaining means for maintaining the availability of one or more applications communicably coupled to the system during the decrypting, encrypting, and replacing, wherein the one or more applications may request the stored value.

20. The method of claim 19, wherein the replacing means comprises an atomic means for performing an operation comprising a plurality of steps configured to replace the stored value with the encrypted value, and a result of each of the plurality of steps is undone if any one of the plurality of steps fails.

21. The method of claim 20, further comprising partitioning means for partitioning the stored values into a plurality of partitions, and reserving one or more of the plurality of partitions as reserved partitions, wherein the operation comprises a step of determining whether the reserved partitions are still reserved.

22. The method of claim 19, wherein the replacing means comprises modifying a date representing when the stored value was last modified to reflect an original modification date.

23. The method of claim 19, wherein the decrypting means comprises modifying a date representing when the stored value was last read to reflect an original read date.

24. The method of claim 19, wherein at least one of decrypting means or the encrypting means comprises decrypting or encrypting data using a hardware-based encryption technology.
